(19) United States
(12) Patent Application Publication
(10) Pub. No.: US 2021/0345609 A1
(43) Pub. Date: Nov. 11, 2021

(54) AMINOCARBOXYLIC ACID CHELATING AGENT WITH ANTIFUNGAL ACTIVITY AND SYNERGISTIC USE THEREOF WITH OTHER STERILANTS

(71) Applicant: Nanjing Jixing Biotechnology Development Co., Ltd., Nanjing City (CN)

(72) Inventors: Jianbi PAN, Nanjing City (CN); Xiushi SONG, Nanjing City (CN); Kaixin GU, Nanjing City (CN)

(73) Assignee: Nanjing Jixing Biotechnology Development Co., Ltd., Nanjing City (CN)

(21) Appl. No.: 17/125,061

(22) Filed: Dec. 17, 2020

(30) Foreign Application Priority Data
May 11, 2020 (CN) 202010389990.8

(51) Int. Cl. A01N 37/44

(52) U.S. Cl. CPC A01N 37/44

(57) ABSTRACT

The disclosure belongs to the technical field of pesticides, and relates to an aminocarboxylic acid chelating agent with antifungal activity and synergistic use thereof with other sterilants. The aminocarboxylic acid chelating agent and salts thereof used alone or in combination can effectively inhibit growth and development of Fusarium, Botrytis cinerea, Pyricularia, Trichoderma, Penicillium and oomycetes with an effective antimicrobial concentration of 0.003-300 mM. They can effectively control wheat scab, rust disease, powdery mildew, rice blast, sheath blight, vegetable gray mold, sclerotinia and other fungal diseases. Combination with organic sulfur, antibiotic, benzimidazole, triazole, methoxyacrylate, succinate dehydrogenase inhibitor sterilants and oomcide drugs, can reduce amount of pesticides applied and improve control effects.

### TECHNICAL FIELD

The disclosure belongs to the technical field of pesticides, and specifically relates to use of an aminocarboxylic acid chelating agent in controlling fungal diseases and synergistic use thereof with other sterilants.

### BACKGROUND

Fungal diseases are common in agricultural production and rank first among plant diseases. With changes in proportions of various crops and farming systems, along with climate change and other reasons, the fungal diseases are spread wider in recent years, causing great pressure on the task of increasing or stabilizing grain production. As an important measure in plant protection and control, chemical control plays a great role in agricultural production. With development of biotechnology, single-target selective sterilants are favored in agricultural production due to advantages thereof such as high selectivity and safety. However, target differentiation and mutation has led to the fact that modem sterilants are very easy to cause drug resistance, resulting in a lower efficiency of drugs in control of diseases, an increased risk of diseases, and an increased demand for new drugs in agricultural production.

An aminocarboxylic acid chelating agent contains carboxyl and amine (amino) chelating groups, such as ethylenediaminetetraacetic acid (EDTA) and salts thereof (e.g. EDTANa₁₋₄), diethylenetriaminepentaacetic acid (DTPA) and salts thereof (e.g. DTPANa₁₋₅). The aminocarboxylic acid chelating agent has a wide range of uses, for example, as a bleaching fixer, a dyeing aid, a fiber treatment aid, a cosmetic additive, a blood anticoagulant, a detergent, a stabilizer, a polymerization initiator for synthetic rubber and an indicator. Therefore, EDTA and DTPA are widely used as additives in preservatives and disinfectants in food and pharmaceutical industries to increase stability of formulations. However, there is no report on use of the aminocarboxylic acid chelating agent and salt compounds thereof in control of plant diseases and mold prevention in industry, and synergistic use thereof with an agricultural sterilant.

### SUMMARY

An objective of the disclosure is to provide use of aminocarboxylic acid chelating agent and salts thereof in controlling plant diseases and preventing molds in industry, and as a synergistic agent for agricultural sterilants. The compound can effectively control infection by filamentous fungi and oomycetes, especially Fusarium, Pyricularia oryzae, Botrytis cinerea, Trichoderma, Penicillium, and Phytophthora. It can be combined with benzimidazole (carbendazim), methoxyacrylate (trifloxystrobin) and succinate dehydrogenase (boscalid) drugs to provide a synergistic antimicrobial effect. The present disclosure measures antimicrobial effects of an aminocarboxylic acid chelating agent and salts thereof on different fungi under certain conditions, and finds that the aminocarboxylic acid chelating agent and salts thereof have excellent antimicrobial effects on Fusarium, Pyricularia oryzae, Botrytis cinerea, Trichoderma, Penicillium, and Phytophthora. In vivo experiments further confirm effectiveness of the antimicrobial effects. Field trials also show relatively desired control effects. Further, it is found from determination of ions in fungal cells that, the aminocarboxylic acid chelating agent and salts thereof can chelate metal ions for coenzymes in fungal cells to inhibit activities of important enzymes in life activities. At the same time, they can destroy cell wall and cell membrane structures, increasing permeability of fungal cells. Based on this, the disclosure finds that, the aminocarboxylic acid chelating agent and salts thereof have synergistic effects with organic sulfur (captan), antibiotic (polyoxin), benzimidazole (carbendazim), triazole (tebuconazole), methoxyacrylate (trifloxystrobin), and succinate dehydrogenase inhibitor (boscalid) drugs.

### BRIEF DESCRIPTION OF DRAWINGS

FIG. 1 shows indoor in vivo control effects of an aminocarboxylic acid chelating agent and salts thereof on Fusarium.

FIG. 2 shows indoor in vivo control effects of an aminocarboxylic acid chelating agent and salts thereof on Pyricularia oryzae.

FIG. 3 shows indoor in vivo control effects of an aminocarboxylic acid chelating agent and salts thereof on Botrytis cinerea.

FIG. 4 shows field control effects of an aminocarboxylic acid chelating agent and salts thereof on wheat scab.

FIG. 5 shows effects of an aminocarboxylic acid chelating agent and salts thereof on microelements in fungal cells.

FIG. 6 shows inhibitory effects of an aminocarboxylic acid chelating agent and salts thereof on key enzymes for fungal growth.

### DETAILED DESCRIPTION

The following embodiments are used to explain technical solutions of the present disclosure without limitation.

In the present disclosure, unless otherwise specified, “%” is used to express a concentration in percentage by weight, and “parts” are referring to parts by weight.

The present disclosure relates to the following culture media, the compositions of which are as follows:

Potato dextrose agar (PDA) medium: an extract obtained by boiling 200 g of potato for 15 min, 20 g of glucose, 15 g of agar, and distilled water added to 1,000 ml, sterilized at 121° C. for 20 min.

Carboxymethyl cellulose (CMC) medium: 7.5 g of CMC ester, 0.5 g of NH₄NO₃, 0.5 g of KH₂PO₄, 0.25 g of MgSO₄.7H₂O and 0.5 g of yeast extract; dissolve in distilled water, diluted to 1,000 mL, and sterilized at 121° C. for 20 min.

Synthetic low nutrient agar (SNA) medium: 0.1% of KH₂PO₄, 0.1% of KNO₃, 0.05% of MgSO₄.7H₂O, 0.05% of KCl, 0.02% of glucose and 0.02% of sucrose, diluted to 1,000 ml with distilled water.

### Embodiment 1: Indoor Toxicology Determination of an Aminocarboxylic Acid Chelating Agent and Salts Thereof on Fusarium, Pyricularia Oryzae and Botrytis cinerea

1.1 Experimental Methods and Results for Indoor Determination of Virulence of Fusarium

Experimental methods and specific experimental steps for indoor toxicology determination of Fusarium were as follows:

Step (1): Collection of spores. Five plates (5 mm) evenly distributed on the edge of a medium for Fusarium cultured at 25° C. for 3 d were taken and placed in the CMC medium. After culture under shaking at 175 rpm and 25° C. for 5 d, a filtrate was collected with three layers of sterile lens-cleaning paper. Centrifuging was carried out at 10,000 rpm for 10 min. Washing was carried out twice with sterile water (10,000 rpm, 10 min/time). A spore concentration was adjusted to 1×10⁴ ml¹.

Step (2): Setting of concentration gradients of drugs. A series of concentration gradients were obtained by dilution in a constant ratio with EDTA and salts thereof (EDTANa, EDTANₐ₂, EDTANₐ₃, EDTANₐ₄): 0.3 μM-300 mM, DTPA and salts thereof (DTPANa, DTPANₐ₂, DTPANₐ₃, DTPANₐ₄, DTPANₐ₅): 0.3 μM-12.7 mM, and combinations of EDTA and DTPA: 3 μM-300 mM EDTA+3 μM-12.7 mM DTPA. Drugs and spore solutions were mixed, drawn to a cell culture plate and incubated in a thermostat incubator at 25° C. for a period of time.

Step (3): Investigation results and statistical analysis. When a spore germination rate of control group was >90%, spore germination was observed and analyzed statistically.

Spore germination rate (%)=number of germinated spores/number of inspected spores×100

Corrected germination rate (%)=(germination rate for control−germination rate for treatment)/(100−germination rate for control)×100

A spore germination method was used indoors to determine EC₅₀ values of the EDTA and salts thereof, the DTPA and salts thereof, and the combinations of EDTA and DTPA in inhibiting growth of Fusarium. Preferably, antimicrobial results of EDTA and DTPA were shown in Table 1.

TABLE 1
Effective medium concentrations (EC₅₀ values) of EDTA,
DTPA, EDTA + DTPA against different Fusarium

| | | |
|---|---|---|
| Microbial strain | Regression equation | EC₅₀ (μg ml⁻¹) |

EDTA

| | | |
|---|---|---|
| F. asiaticum | y = 0.89 + 4.36× | 8.76 |
| F. graminearum | y = 1.35 + 2.92× | 17.78 |
| F. oxysporum | y = 3.29 + 1.37× | 17.67 |
| F. solani | y = 2.94 + 1.66× | 17.50 |
| F. verticilloides | y = 3.25 + 1.37× | 19.02 |

DTPA

| | | |
|---|---|---|
| F. asiaticum | y = 1.22 + 4.01× | 8.76 |
| F. graminearum | y = 2.35 + 2.19× | 16.22 |
| F. oxysporum | y = 1.33 + 2.94× | 17.77 |
| F. solani | y = 3.75 + 1.00× | 17.80 |
| F. verticilloides | y = 4.39 + 0.48× | 18.82 |
| F. asiaticum | y = 0.77 + 4.49× | 8.76 |
| F. graminearum | y = 1.12 + 3.16× | 16.89 |
| F. oxysporum | y = 2.31 + 2.17× | 17.23 |
| F. solani | y = 1.28 + 2.99× | 17.57 |
| F. verticilloides | y = 2.75 + 1.78× | 18.26 |

1.2 Experimental Methods and Results for Indoor Determination of Virulence of Pyricularia oryzae

Experimental methods and specific experimental steps for indoor toxicology determination of Pyricularia oryzae were as follows:

Step (1): Collection of spores. Sterile water was used to repeatedly wash a plate with Pyricularia oryzae cultured at 28° C. for 7 d. Three layers of sterile lens-cleaning paper were used to filter used water for washing to collect a filtrate. Centrifuging was carried out at 10,000 rpm for 10 min. Washing was carried out twice with sterile water (10,000 rpm, 10 min/time). A spore concentration was adjusted to 1×10⁴ ml⁻¹.

Step (2): Setting of concentration gradients of drugs. Concentration gradients of drugs were obtained as described in the above section 1.1. Drugs and spore solutions were mixed, drawn to a cell culture plate and incubated in a thermostat incubator at 28° C. for a period of time.

Step (3): Investigation results and statistical analysis.

EC₅₀ values of the EDTA and salt thereof (EDTANa₄) DTPA and salt thereof (DTPANa₅), and combinations of EDTA and DTPA in inhibiting growth of Pyricularia oryzae were determined. Preferably, antimicrobial results of EDTA, EDTANa₄, DTPA, DTPANa₅, EDTA+DTPA (in a molar ratio of 100,000:1 or 1:4, 233) were shown in Table 2.

TABLE 2
EC₅₀ values of EDTA, DTPA, EDTA +
DTPA against Pyricularia oryzae

| Compound | Regression equation | EC₅₀ (μg ml⁻¹) |
|---|---|---|
| EDTA | y = 0.72 + 4.33× | 9.75 |
| EDTANa₄ | y = 0.95 + 4.23× | 9.01 |
| DTPA | y = −0.85 + 6.00× | 9.45 |
| DTPANa₅ | y = 0.96 + 4.16× | 9.32 |
| EDTA + DTPA | y = 1.37 + 3.68× | 9.72 |
| (molar ratio of 100,000:1) | | |
| EDTA + DTPA | y = 1.01 + 3.95× | 10.21 |
| (molar ratio of 1:4,233) | | |

1.3 Experimental Methods and Results for Indoor Determination of Virulence of Botrytis cinerea

Experimental methods and specific experimental steps for indoor toxicology determination of Botrytis cinerea were as follows:

Step (1): Collection of spores: Five plates (5 mm) evenly distributed on the edge of a medium for Botrytis cinerea cultured at 25° C. for 3 d were taken and placed in the PDA medium. After culturing at 25° C. for 7 d, the PDA medium was washed with sterile water. A filtrate was collected with three layers of sterile lens-cleaning paper. Centrifuging was carried out at 10,000 rpm for 10 min. Washing was carried out twice with sterile water (10,000 rpm, 10 min/time). A spore concentration was adjusted to 1×10⁴ ml⁻¹.

Step (2): Setting of concentration gradients of drugs. Concentration gradients of drugs were obtained as described in the above section 1.1. Drugs and spore solutions were mixed, drawn to a cell culture plate and incubated in a thermostat incubator at 25° C. for a period of time.

Step (3): Investigation results and statistical analysis.

A spore germination method was used indoors to determine EC₅₀ values of EDTA and salt thereof (EDTANa₂), DTPA and salt thereof (DTPANa₃), and combination of EDTA and DTPA (in a molar ratio of 2:1) in inhibiting growth of Botrytis cinerea. Results were shown in Table 3.

TABLE 3
EC₅₀ values of EDTA, DTPA, EDTA + DTPA
against Botrytis cinerea

| Compound | Regression equation | EC₅₀ (μg ml⁻¹) |
|---|---|---|
| EDTA | y = 1.11 + 18.33× | 1.63 |
| EDTANa₂ | y = 3.57 + 29× | 1.12 |
| DTPA | y = −0.32 + 19.91× | 1.85 |
| DTPANa₃ | y = 4.21 + 2.88× | 1.88 |
| EDTA + DTPA | y = 3.56 + 5.75× | 1.78 |
| (molar ratio of 2:1) | | |

1.4 Experimental Methods and Results for Indoor Determination of Virulence of Penicillium and Trichoderma

Step 1): Setting of concentration gradients of drugs. A series of concentration gradients were obtained by preparation, with EDTA and salts thereof (EDTANa₂, EDTANa₃, EDTANa₄): 0.3 μM-300 mM, DTPA: 0.3 μM-300 mM, and combination of EDTA and DTPA: 3 μM-300 mM EDTA+3 μM-12.7 mM DTPA.

Step 2): Determination of EC₅₀ values of drugs against Penicillium and Trichoderma with a hyphae growth rate method (PDA plate method)

Preferred results were shown in Table 4.

TABLE 4
EC₅₀ values of EDTA, DTPA and EDTA + DTPA
against Penicillium and Trichoderma

| | | |
|---|---|---|
| Compound | Regression equation | EC₅₀ (μg ml⁻¹) |

Penicillium

| | | |
|---|---|---|
| EDTA | y = 1.44 + 7.15× | 3.1486 |
| DTPA | y = 3.28 + 2.69× | 4.3704 |
| EDTA + DTPA | y = 1.89 + 6.25× | 3.1439 |
| (molar ratio of 12:1) | | |

Trichoderma

| | | |
|---|---|---|
| EDTA | y = 3.09 + +2.43× | 6.122 |
| DTPA | y = 4.79 + 0.24× | 7.6421 |
| EDTA + DTPA | y = 3.65 + 1.64× | 6.6586 |
| (molar ratio of 1:32) | | |

1.5 Experimental Methods and Results for Indoor Determination of Virulence of Phytophthora

Step 1): Setting of concentration gradients of drugs. A series of concentration gradients were obtained by preparation, with EDTA and salts thereof (EDTANa₂, EDTANa₃, EDTANa₄): 0.3 μM-300 mM, DTPA: 0.3 μM-12.7 mM, and combination of EDTA and DTPA: 3 μM-300 mM EDTA+3 μM-12.7 mM DTPA.

Step 2): Determination of EC₅₀ values of drugs against pathogenic Phytophthora with a hyphae growth rate method (PDA plate method)

Preferred results were shown in Table 5.

TABLE 5
EC₅₀ values of EDTA, DTPA and EDTA + DTPA
against pathogenic Phytophthora

| Compound | Regression equation | EC₅₀ (μg ml⁻¹) |
|---|---|---|
| EDTA | y = 1.25 + 2.97× | 18.23 |
| EDTANa₃ | y = 2.35 + 2.13× | 17.56 |
| DTPA | y = 3.31 + 1.29× | 20.35 |
| EDTANa₂ | y = 3.62 + 1.07× | 19.39 |
| EDTA + DTPA | y = 2.24 + 2.13× | 19.75 |
| (molar ratio of 80:1) | | |

### Embodiment 2 Indoor In Vivo Efficacy of EDTA and Salts Thereof, DTPA and Salts Thereof, and Combinations of EDTA and DTPA on Fusarium, Pyricularia Oryzae, and Botrytis cinerea

(1) Indoor In Vivo Efficacy of EDTA and Salts Thereof, DTPA and Salts Thereof, and Combination of EDTA and DTPA on Fusarium

Seeds of Yumai 35 were sterilized with 0.1% mercury dichloride for 5 min, rinsed with sterile water for 3 times and immersed for 2 h. The seeds were evenly placed in plastic boxes laid with double layers of sterile filter paper with 30 seeds a box. Cultivation was carried out at 25° C. with 90% humidity and a cycle of 12 h light and 12 h dark in a light incubator for 2 d. When coleoptiles grew to 2.5 cm long, EDTA and salt thereof (3 μM-300 mM), DTPA and salt thereof (3 μM-12.7 mM), and combined solutions of EDTA and DTPA were sprayed. 12 h later, tips of the coleoptiles were cut. Cut wounds were inoculated with 5 μL of 5×10⁵ cells/mL Fg2021 spore solution respectively. Cultivation was carried out in the light incubator. 7 d later, length of disease spot was investigated. Preferred results were shown in FIG. 1, where treatments with 7.5 mM EDTA and salt thereof (EDTANa₄), 15 μM DTPA and salt thereof (DTPANa₅), and combinations of EDTA and DTPA (molar ratios of 100,000:1; 3,000:1; 1:200; 1:2,000) significantly inhibited infection ability of Fusarium Fg2021, and resulted in significantly shorter disease spots on wheat seedlings compared with those on control wheat seedlings.

(2) Indoor In Vivo Efficacy of EDTA and Salts Thereof, DTPA and Salts Thereof, and Combinations of EDTA and DTPA on Pyricularia oryzae

Barley seedlings were cultured at 30° C. with a cycle of 12 h light and 12 h dark for 6.5 d. EDTA and salts thereof (3 μM-300 mM), DTPA and salts thereof (3 μM-12.7 mM), and combination of EDTA and DTPA were sprayed on barley leaves. 12 h later, sterilized scissors were used to cut sections of 7-8 cm from tip ends of the leaves which were then placed in a petri dish moisturized with filter paper. 5 μL of 2×10⁴ spores/mL Pyricularia oryzae Guy 11 spore solution was inoculated on the leaves and cultured under the same conditions for 6 d. Length of disease spot was statistically analyzed.

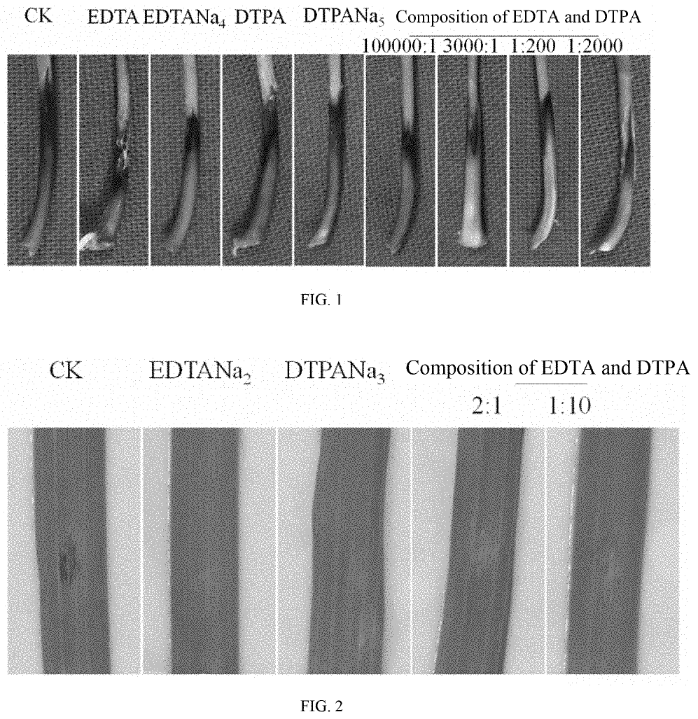

Analysis showed that, treatments with EDTA and salts thereof, DTPA and salts thereof, and combinations of EDTA and DTPA significantly reduced pathogenicity of Pyricularia oryzae. Preferably, treatments with 30 mM EDTANₐ₂, 10 mM DTPANa₃, EDTA+DTPA (molar ratios of 2:1 and 1:10) significantly inhibited infectivity of Pyricularia oryzae Guy11, showing significantly reduced disease spots (FIG. 2).

(3) Indoor In Vivo Efficacy of EDTA and Salts Thereof, DTPA and Salts Thereof, and Combinations of EDTA and DTPA on Botrytis cinerea

Cucumber seedlings were cultured at 30° C. with a cycle of 12 h light and 12 h dark for 14 d in a greenhouse. EDTA and salts thereof (3 μM-300 mM), DTPA and salts thereof (3 μM-12.7 mM), and combinations of EDTA and DTPA were sprayed on cucumber leaves. 12 h later, sterilized scissors were used to cut sections of the leaves which were then placed in a petri dish with petioles moisturized with cotton balls. 10 μL of 1×10⁵ spores/mL Botrytis cinerea spore solution was inoculated on the leaves and cultured under the same conditions for 4 d. Size of the disease spot was statistically analyzed.

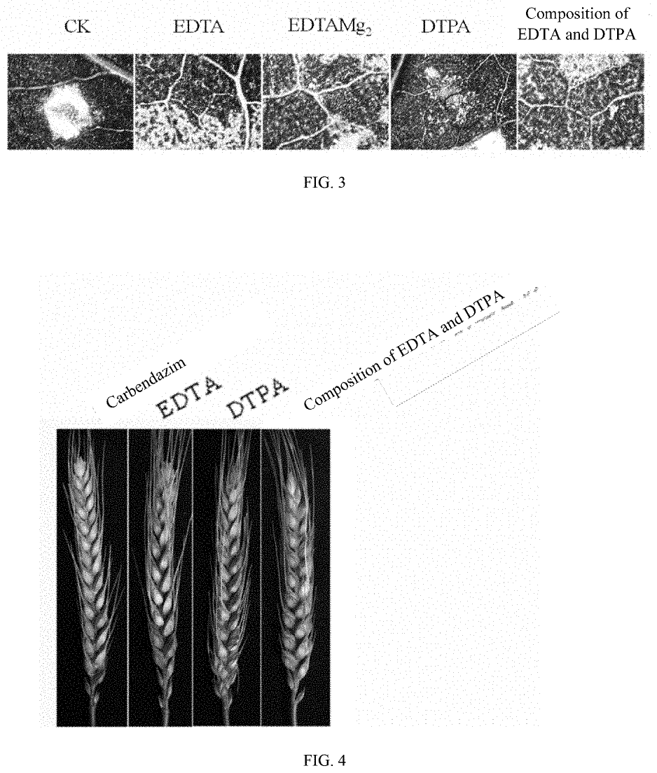

Analysis showed that, EDTA and salts thereof, DTPA and salts thereof, and combinations of EDTA and DTPA significantly inhibited pathogenicity of Botrytis cinerea. Preferably, treatments with 25 mM EDTA, 30 mM EDTAM_{g2}, 10 mM DTPA and EDTA+DTPA (molar ratio of 2:1) resulted in significantly shorter disease spots on cucumber leaves compared with those on control leaves (FIG. 3).

### Embodiment 3 Field Efficacy Test

Test time: 2018 and 2019

Test location: Nanjing of Jiangsu in China

Test crop: wheat

Object to be controlled: wheat scab

Test methods: 0, 7, 70, 100 g ha⁻¹ of EDTA and salts thereof (EDTANa₂, EDTANa₃, EDTANa₄) or DTPA and salt thereof (DTPACa₂Na), combinations of EDTA and DTPA (molar ratios of 200:1; 20:1; 2:1; 1:20; 1:200; 1:2,000) were sprayed on wheat at a flowering period. 140 g ha⁻¹ of carbendazim was used as a control drug. 24 h later, 1 ml of 1×10⁴ spores/mL Fg2021 spore suspension was sprayed on wheat ears. Each treatment included 100 plants of wheat.

Test results: number of diseased spikelets were observed and counted on day 14 or day 21 respectively. Preferably, FIG. 4 showed diseased spikelets after treatments with 140 g ha⁻¹ carbendazim, 7 g ha⁻¹ EDTA, 7 g ha⁻¹ DTPA, and combination of EDTA and DTPA (molar ratio of 2:1). It can be seen visually from the picture that, wheat ears after drug treatments had significantly lighter disease compared with the control group, with control effects in different plots in the field being 37.6%-88.4%.

### Embodiment 4 Main Target and Action Mechanism of Aminocarboxylic Acids as Chelates and Salts Thereof in Fungi

(1) Aminocarboxylic Acids as Chelates and Salts Thereof Affected Cell Wall Formation and Cell Permeability

Fusarium spores were cultured in the SNA medium and an SNA medium containing aminocarboxylic acids as chelates and salts thereof respectively for 48 h at 25° C. Then hyphae were collected, and cell wall permeability of the hyphae after treatment was measured. Taking 0.15 mM EDTA as an example, after the hyphae were treated with the aminocarboxylic acids as chelates and salts thereof, cell permeability was significantly reduced.

(2) Aminocarboxylic Acids as Chelates and Salts Thereof Showed Antimicrobial Activities on Fungi Mainly Through Chelating Cofactors

A series of different concentrations of MgCl₂, CaCl₂ or MnCl₂ (0, 0.3, 0.6, 0.9, 1.2, 2.4 mM) were added to an SNA solution containing aminocarboxylic acids as chelates and salts thereof respectively. 50 μl of mixed solution was taken and mixed uniformly with 50 μl of 2×10³ spores/ml⁻¹ Fusarium spore suspension and placed in a 96-well cell culture plate at 25° C. for 52 h. Then OD₂₉₀ value was measured with a spectrophotometer. At the same time, a 10⁴ spores/ml⁻¹ spore solution was inoculated into the SNA medium and the SNA medium containing aminocarboxylic acids as chelates and salts thereof, and cultured for 7 d at 25° C. Hyphae were collected for determination of microelements in the hyphae.

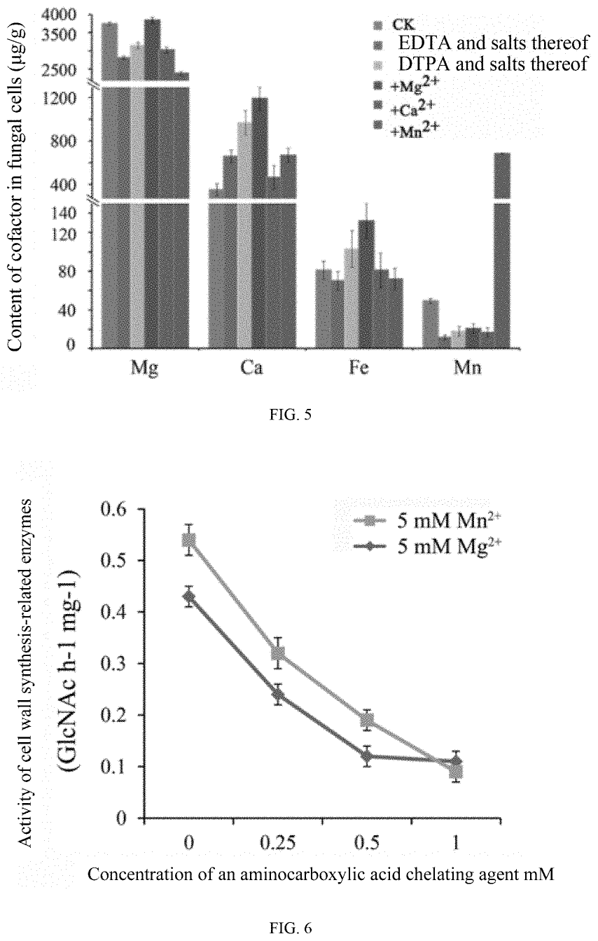

Results were shown in FIG. 5. An aminocarboxylic acid chelating agent significantly reduced contents of active cofactors for key enzymes in fungal cells, causing slow fungal growth.

(3) Inhibitory Effects of an Aminocarboxylic Acid Chelating Agent and Salts Thereof on Key Enzymes in Fungi

Taking key enzymes for fungal growth (cell wall synthesis-related enzymes) as an example, activities of cell wall synthesis-related enzymes in the presence of different cofactors were measured with a liquid scintillator. It was found that, the cell wall synthesis-related enzymes had the highest activities when cofactors were present, and addition of the aminocarboxylic acid chelating agent and salt thereof inhibited the activities of cell wall synthesis-related enzymes by 85% or more (FIG. 6).

### Embodiment 5 Synergistic Effect of Aminocarboxylic Acids as Chelates and Salts Thereof with Organic Sulfur (Mancozeb and Captan), Antibiotic (Polyoxin), Triazole (Tebuconazole), Benzimidazole (Carbendazim), Methoxyacrylate (Trifloxystrobin), Succinate Dehydrogenase (Boscalid) and Omicide (Cymoxanil) Drugs

Component A referred to one of EDTA and salts thereof, DTPA and salts thereof and combination of EDTA and DTPA. Component B referred to one of organic sulfur (taking mancozeb and captan as examples), antibiotic (taking polyoxin as an example), triazole (taking tebuconazole as an example), benzimidazole (taking carbendazim as an example), methoxyacrylate (taking trifloxystrobin as an example), succinate dehydrogenase inhibitor (taking boscalid as an example), and omicide (taking cymoxanil as an example) drugs. Tests were carried out with combination of effective components A and B in a mass ratio of 0.5:50, 1:30, 1:10, 1:1, 10:1 and 50:1 to determine co-toxicity coefficients or synergy ratio (SR) values for fungi.

Taking Botrytis cinerea as an example, results were shown in Table 6. Different ratios in combinations resulted in different synergistic effects. The aminocarboxylic acids as chelates and salts thereof had different effects when combined with different sterilants (>1.5 representing a relatively strong synergistic effect), and preferred ratios for combination was (0.5-30):(1-50).

TABLE 6
Synergistic effect of aminocarboxylic acids as chelates
and salts thereof in combination with organic sulfur
(mancozeb and captan), antibiotic (polyoxin), triazole
(tebuconazole), benzimidazole (carbendazim), methoxyacrylate
(trifloxystrobin), succinate dehydrogenase (boscalid)
and omicide (cymoxanil) drugs

| | | Measured | Theoretical | |
|---|---|---|---|---|
| | | EC₅₀ | EC₅₀ | |
| | | value/ | value/ | |
| Drug for combination | Ratio | (μg/ml) | (μg/ml) | SR |
| EDTA + | 1:50 | 0.0665 | 0.0612 | 0.92 |
| carbendazim | 1:30 | 0.0220 | 0.0619 | 2.82 |
| | 1:10 | 0.0156 | 0.0658 | 4.21 |
| | 1:1 | 0.0175 | 0.1157 | 6.62 |
| | 10:1 | 0.1398 | 0.4824 | 3.45 |
| EDTANa₂ + | 1:50 | 0.75 | 1.04 | 1.38 |
| tebuconazole | 1:30 | 0.67 | 1.04 | 1.56 |
| | 1:10 | 0.56 | 1.07 | 1.92 |
| | 1:1 | 0.63 | 1.26 | 2.01 |
| | 10:1 | 0.85 | 1.55 | 1.83 |
| EDTANa₄ + | 1:50 | 5.88 | 5.12 | 0.87 |
| captan | 1:30 | 5.03 | 4.98 | 0.99 |
| | 1:10 | 3.36 | 4.43 | 1.32 |
| | 1:1 | 0.95 | 2.50 | 2.63 |
| | 10:1 | 0.83 | 1.74 | 2.1 |
| EDTANa₃ + | 1:50 | 0.22 | 0.24 | 1.12 |
| polyoxin | 1:30 | 0.20 | 0.25 | 1.21 |
| | 1:10 | 0.17 | 0.26 | 1.56 |
| | 1:1 | 0.25 | 0.42 | 1.68 |
| | 10:1 | 0.87 | 1.07 | 1.23 |
| DTPA + | 1:50 | 0.0078 | 0.0061 | 0.78 |
| trifloxystrobin | 1:30 | 0.0061 | 0.0062 | 1.01 |
| | 1:1 | 0.0046 | 0.012 | 2.62 |
| | 20:1 | 0.065 | 0.1189 | 1.84 |
| | 50:1 | 0.152 | 0.2663 | 1.75 |
| DTPANa₅ + | 1:50 | 0.30 | 0.19 | 0.65 |
| cymoxanil | 1:30 | 0.17 | 0.19 | 1.14 |
| | 1:1 | 0.18 | 0.35 | 1.89 |
| | 20:1 | 1.08 | 1.38 | 1.27 |
| | 50:1 | 1.35 | 1.69 | 1.25 |
| 2 parts of EDTA + | 1:50 | 3.73 | 2.35 | 0.63 |
| 1 part of DTPA + | 1:30 | 2.21 | 2.35 | 1.06 |
| boscalid | 1:1 | 1.14 | 2.17 | 1.90 |
| | 20:1 | 1.08 | 2.02 | 1.87 |
| | 50:1 | 1.22 | 2.02 | 1.65 |

The above disclosed contents are only preferred embodiments of the present disclosure, and are not intended to limit the claimed scope of the present disclosure. Therefore, equivalent changes made according to the claims of the present disclosure are still within the scope of the present disclosure.

What is claimed is:

1. A method for controlling agricultural pathogenic fungi (comprising Fusarium, Botrytis cinerea, Pyricularia oryzae, and Phytophthora causing potato late blight), molds in life (comprising Trichoderma and Penicillium) and oomycete diseases with an aminocarboxylic acid chelating agent, comprising a step of applying the aminocarboxylic acid chelating agent.

2. The method according to claim 1, wherein the aminocarboxylic acid chelating agent is a single compound selected from one of or a composition comprising at least two of ethylenediaminetetraacetic acid (EDTA), diethylenetriaminepentaacetic acid (DTPA) and salts thereof, EDTA Me^{+/++}₍ₙ₎ and DTPA Me+/++(n).

3. The method according to claim 2, wherein the Me^{+/++} is sodium, calcium, magnesium, manganese, zinc or iron ion and n is 1-5.

4. The method according to claim 1, wherein when the aminocarboxylic acid chelating agent is a single compound, the single compound is used in a concentration of 0.003-300 mM/L; when the aminocarboxylic acid chelating agent is a composition comprising EDTA and DTPA, a molar ratio of the EDTA to the DTPA is (1-100,000):(4, 233-1).

5. The method according to claim 1, wherein the aminocarboxylic acid chelating agent can chelate metal ions for key coenzymes of fungal proteases and selectively interfere with growth and development of fungi.

6. The method according to claim 1, wherein the aminocarboxylic acid chelating agent is used as a fungal cell permeability enhancer which can chelate metal ion components of fungal cell wall and cell membrane, destroying selective permeability of cells.

7. The method according to claim 2, further comprising applying the aminocarboxylic acid chelating agent with a fungicide for synergistic use, wherein the aminocarboxylic acid chelating agent can chelate metal ions for key coenzymes of target proteases of sterilant actions and produce synergistic effects with sterilants targeting the proteases, or increase absorption of sterilants by fungi and produce synergistic effects.

8. The method according to claim 2, further comprising applying a combination of one or more of the aminocarboxylic acid chelating agent of the EDTA Me^{+/++}₍ₙ₎ and the DTPA Me^{+/++}₍ₙ₎ with one or more of sterilants comprising thiocarbamate, antibiotic, triazole, methoxyacrylate, succinate dehydrogenase inhibitor and omicide drugs, wherein a molar ratio of the chelating agent to the omicide drugs is (0.5-50):(50-1).

9. The method according to claim 2, wherein when the aminocarboxylic acid chelating agent is a single compound, the single compound is used in a concentration of 0.003-300 mM/L; when the aminocarboxylic acid chelating agent is a composition comprising EDTA and DTPA, a molar ratio of the EDTA to the DTPA is (1-100,000):(4, 233-1), and the single compound and the composition can further be used to control oomycete diseases.

10. The method according to claim 3, wherein when the aminocarboxylic acid chelating agent is a single compound, the single compound is used in a concentration of 0.003-300 mM/L; when the aminocarboxylic acid chelating agent is a composition comprising EDTA and DTPA, a molar ratio of the EDTA to the DTPA is (1-100,000):(4, 233-1), and the single compound and the composition can further be used to control oomycete diseases.

11. The method according to claim 2, wherein the aminocarboxylic acid chelating agent can chelate metal ions for key coenzymes of fungal proteases and selectively interfere with growth and development of fungi.

12. The method according to claim 3, wherein the aminocarboxylic acid chelating agent can chelate metal ions for key coenzymes of fungal proteases and selectively interfere with growth and development of fungi.

13. The method according to claim 2, wherein the aminocarboxylic acid chelating agent is used as a fungal cell permeability enhancer which can chelate metal ion components of fungal cell wall and cell membrane, destroying selective permeability of cells.

14. The method according to claim 3, wherein the aminocarboxylic acid chelating agent is used as a fungal cell permeability enhancer which can chelate metal ion components of fungal cell wall and cell membrane, destroying selective permeability of cells.

15. The method according to claim 4, wherein the aminocarboxylic acid chelating agent is used as a fungal cell permeability enhancer which can chelate metal ion components of fungal cell wall and cell membrane, destroying selective permeability of cells.

16. The method according to claim 3, further comprising applying the aminocarboxylic acid chelating agent in combination with a fungicide for synergistic use, wherein the aminocarboxylic acid chelating agent can chelate metal ions for key coenzymes of target proteases of sterilant actions and produce synergistic effects with sterilants targeting the protease, or increase absorption of sterilants by fungi and produce synergistic effects.

17. The method according to claim 4, further comprising applying the aminocarboxylic acid chelating agent in combination with a fungicide for synergistic use, wherein the aminocarboxylic acid chelating agent can chelate metal ions for key coenzymes of target proteases of sterilant actions and produce synergistic effects with sterilants targeting the proteases, or increase absorption of sterilants by fungi and produce synergistic effects.

18. The method according to claim 5, further comprising applying the aminocarboxylic acid chelating agent in combination with a fungicide for synergistic use, wherein the aminocarboxylic acid chelating agent can chelate metal ions for key coenzymes of target proteases of sterilant actions and produce synergistic effects with sterilants targeting the proteases, or increase absorption of sterilants by fungi and produce synergistic effects.

19. The method according to claim 6, further comprising applying the aminocarboxylic acid chelating agent with a fungicide for synergistic use, wherein the aminocarboxylic acid chelating agent can chelate metal ions for key coenzymes of target proteases of sterilant actions and produce synergistic effects with sterilants targeting the proteases, or increase absorption of sterilants by fungi and produce synergistic effects.

20. The method according to claim 7, further comprising applying a combination of one or more of the aminocarboxylic acid chelating agent of the EDTA Me^{+/++}₍ₙ₎ and the DTPA Me^{+/++}₍ₙ₎ and one or more of sterilants comprising thiocarbamate, antibiotic, triazole, methoxyacrylate, succinate dehydrogenase inhibitor and omicide drugs, wherein a molar ratio of the chelating agent to the omicide drugs is (0.5-50):(50-1).
